(19) United States
(12) Patent Application Publication
(10) Pub. No.: US 2002/0175431 A1
(43) Pub. Date: Nov. 28, 2002

(54) Artificial skull model and method for manufacturing the same

(76) Inventors: Shigeru Shimosawa, Ikoma-gun (JP); Sadashi Shimosawa, Nagoya-shi (JP)

Correspondence Address: THOMPSON HINE L.L.P., 2000 COURTHOUSE PLAZA , N.E., 10 WEST SECOND STREET, DAYTON, OH, 45402, US

(21) Appl. No.: 10/154,701

(22) Filed: May 24, 2002

(30) Foreign Application Priority Data
May 24, 2001 (JP) 2001-155864

(51) Int. Cl. B29C 33/40

(52) U.S. Cl. 264/28; 264/222

(57) ABSTRACT

The object of the present invention for solving the problems as hitherto described is to provide a method for securing the freedom of excision of the skull during operation while enabling a model that is almost fitted to the excised portion to be obtained, and a model for use in the method.

The present invention for attaining the foregoing objects provides a method for manufacturing an artificial skull model comprising the steps of: forming an outer model by duplicating the impression of the surface of a skull to be excised with a curing type impression material; filling and pressing a soft seal material onto the excised portion of the skull using the outer mold as a tray to form a main mold; filling an upper mold to an extent capable of duplicating at least the impression of the side face of the main mold, followed by releasing the main mold; replacing the remaining space with a slurry of a ceramic powder followed by freezing the slurry; and removing and firing the frozen model. As an additional mean, a calcium phosphate powder may be adhered on at least the side face of the frozen model. At replacing slurry of the ceramic powder, a reinforcing material of a metal may be previously contained in the slurry of the ceramic powder and then the slurry of the ceramic powder is frozen.

### BACKGROUND OF THE INVENTION

### FIELD OF THE INVENTION

The present invention relates to an artificial skull bone flap for closing an excised portion of the skull by replacing the excised skull during a surgical operation such as cerebral surgery.

### SUMMARY OF THE INVENTION

Currently, cerebral surgery is roughly categorized into two methods. One method is an operation over the tentorium applied for the cerebrum. In this surgical method, removed bone flap is fixed at the final stage of surgery. Another method is applied for an operation under the tentorium when surgery is completed by leaving the shaved portion of the skull (lateral suboccipital approach). Although this removed bone flap is returned to its original position in the case of the middle line approach, fixing of the bone flap after the surgery is poor. In the case of the transpetrosal approach, on the other hand, the skull should be repaired when, for example, the temporal bone is removed.

In the surgery as described above, it is known that a previously prepared artificial model made of a metal or ceramic may be applied in place of the bone excised. However, there arises a surgical problem in use of a preformed material. When such model is used, the size of the skull to be excised should be fitted to the size of the model to restrict the freedom of the operator. When one attempts to secure the freedom, a number of variations and sizes of the artificial models should be previously prepared. In addition, since only one of them is practically used, it is not economical in view of the cost of surgery.

It is practically impossible to make the shape of the excised portion to completely fit to the shape of the model during surgery that should be performed within a limited length of time, and the shape of the skull is not often improved.

The object of the present invention for solving the problems as hitherto described is to provide a method for securing the freedom of excision of the skull during operation while enabling a model that is almost fitted to the excised portion to be obtained, and a model for use in the method.

The present invention for attaining the foregoing objects provides a method for manufacturing an artificial skull model comprising the steps of: forming an outer mold by duplicating the impression of the surface of a skull to be excised with a curing type impression material; filling and pressing a soft seal material onto the excised portion of the skull using the outer mold as a tray to form a main mold; filling an upper mold to an extent capable of duplicating at least the impression of the side face of the main mold, followed by releasing the main mold; replacing the remaining space with a slurry of a ceramic powder followed by freezing the slurry; and removing and firing the frozen model. While the outer mold is used as a tray for molding the main part of the impression, it also functions for duplicating the impression of the surface configuration of the skull itself. The main mold functions in order to duplicate the mold around the excised part, and serves as a mean for manufacturing a precise model of the excised part after closing the entire mold. The upper mold serves as a core by being combined with the outer mold. The slurry of the ceramic powder has a composition for constructing the model, precisely reconstructs the inside configuration of the core, and maintains this configuration so long as it is frozen. After firing, a model precisely reconstructing the excised part can be obtained. It is also possible to retouch the surface by piling or shaving immediately after freezing.

As an additional mean, a calcium phosphate powder may be adhered on at least the side face of the frozen model before firing. Furthermore, the calcium phosphate powder may be previously contained in the slurry of the ceramic powder. Moreover, a reinforcing material of a metal such as titanium that is safe for the living body and being durable against rust and corrosion may be embedded in the slurry of the ceramic powder in the form of a mesh, thin plate or cylinder of the metal.

The skull model itself was manufactured by the steps comprising: forming an outer mode by duplicating the impression of the surface of the skull to be excised; forming a main mold by filling and pressing a soft impression material onto the surface of the skull to be excised using the main mold as a tray; filling an upper mold to an extent so as to be able to duplicate at least the side face of the main mold followed by releasing the main mold; replacing promptly with slurry of the ceramic powder followed by freezing the slurry; and removing and firing the frozen model. The function of each element in this mean is the same as described in the manufacturing method. In an optional means, the powder of calcium phosphate may be adhered at least on the side face of the main mold before freezing, and the adhered power is fired to provide a fired layer of calcium phosphate on the side face of the main mold.

The slurry of the ceramic powder may be prepared by mixing a ceramic powder with a high melting point powder such as an alumina powder, a zirconia powder or a silicon dioxide powder. While the alumina powder and the like having a high melting point does not melt, the ceramic powder having a low melting point is melt to tightly adhere on the alumina powder and the like to form a monolithic porous model by restricting shrinkage as a whole. The ceramic powder may be additionally adhered before firing and after freezing in order to make the surface layer dense, wherein the surface layer comprises a dense molten ceramic while the inside maintains a porous structure.

### BRIEF DESCRIPTION OF THE DRAWINGS

FIG. 1 is a generalized process flow chart of surgery according to the present invention.

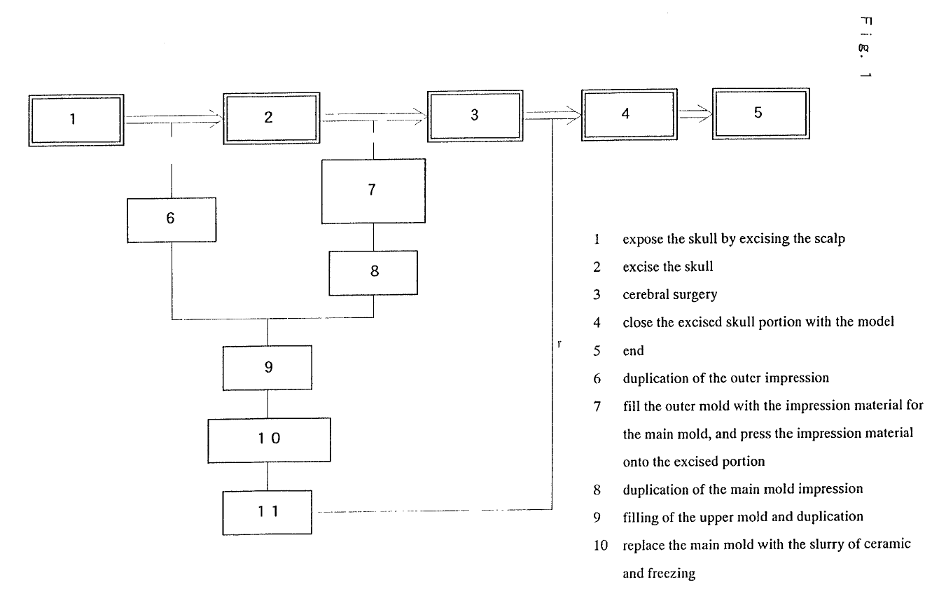

FIG. 2 is a perspective view showing an embodiment of the present invention.

### DESCRIPTION OF THE PREFERRED EMBODIMENTS

Preferred embodiments of the present invention will be described in accordance with the drawing attached. For easy description, only an outline of the order of operation will be shown in relation to the present invention in the cerebral surgery. First, a skull covering the lesion is exposed by excising a scalp, and the required portion is excised with a surgical apparatuses. Then, an appropriate medical procedure is applied to a brain, and the portion corresponding to the excised skull is closed after completing this operation.

An outer mold of the skull at the portion to be excised is duplicated in the present invention before excision of the skull. Since a prompt procedure is required for duplicating the contour, an immediately curing hard type silicon impression material is preferably used. After confirming that the outer mold has been cured and excising the skull at the site to be excised with a surgical apparatus such as a drill, a relatively soft impression material such as silicone, wax or alginate is filled in the outer mold as a tray. Since the outer mold is constructed of the silicon impression material, it is somewhat elastic. Accordingly, a plaster layer may be appropriately formed on the outside of the outer mold, or on the surface where the impression has not been duplicated, in order to reinforce the outer mold. The essential conditions required for the main mold are to precisely reproduce the outer shape of the skull of a patient, and to precisely reproduce the inner circumference of the excised portion. Since the soft brain permits to be deformed to some extent, the surface of the mold to contact the dura mater is not required to be so precisely regenerated.

While a surgical operator starts to engage in surgical operation, the other operator completes a precise model of the main mold for closing the excised portion of the skull after the surgery. Since surgical operation of the brain usually takes about two hours, the limiting time for completing the model is also about in two hours.

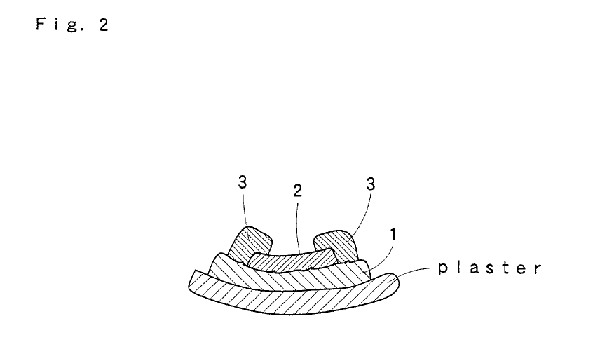

The model is manufactured from the main mold as follows. In the overall cross section of the mold shown in FIG. 2, the main mold 2 corresponding to the portion after excising the skull is formed on the outer mold 1 that has been previously duplicated so that the surface of the main mold matches the surface of the outer mold. Then, an elastic material such as silicon that is cured with time is filled so as to cover the periphery of the main mold 2, and an upper mold 3 is obtained by curing silicon. In other words, the outer mold 1, the main mold 2 and the upper mold 3 are combined as different blocks that make a close contact with each other. A space corresponding to the main mold 2 is formed by removing the upper mold 3 to release the main mold 2, followed by combining the upper mold 3 with the outer mold 1 again. A release agent may be coated on each mold so that the molds can be readily released with each other.

A slurry of a ceramic powder is injected into a space, tighten the slurry with vibration or pressing, if necessary, and the slurry is frozen by an appropriate freezing means. A model is completed by firing the slurry after freezing. A high melting point powder such as alumina, zirconia or silicon dioxide is mixed with the ceramic powder having a fine grain diameter in order not to allow contraction and deformation during firing to be as small as possible. Consequently, the fine ceramic particles is melted and integrated with the high melting point power to form a block of the model as a whole. For example, the ceramic powder comprises a dental ceramic with a melting point of 750 to 950° C., and the high melting point powder comprises alumina (Al₂O₃) with a grain diameter of 10 to 100 μm. The model thus obtained is available as a porous material after firing that has a property resembling to the bone tissue having a not so large specific gravity. Since the model is fired in a temperature range where the high melting point powder does not melt, the non-molten high melting point powder suppresses overall contraction or strain. The grain size of the high melting point powder is not necessarily uniform, and contraction during firing may be more efficiently suppressed by mixing 70% of a powder with a grain diameter of 100 μm and 30% of a fine powder with a grain diameter of 20 μm. A series of this work may be completed within two hours by a conventional procedure. Accordingly, there is no waiting time for completing the model after the surgery. A completed model is available by shaving unnecessary sharp portions such as burrs from the model.

This series of process comprises, for example, the steps of injecting the slurry of the ceramic powder into the core comprising the outer mold 1 and upper mold 3, molding the slurry with compression if necessary, removing rose out moisture on the surface, freezing the slurry together with the core, and releasing the frozen model from the core after completely freezing. Another process comprises the steps of injecting the slurry of the ceramic powder into the core, molding the slurry by compression, adding a dry ceramic powder to the moisture released by compression to form an additional ceramic slurry with the released moisture, freezing the slurry together with the core, and releasing the frozen model from the core after completely freezing. Any of two processes may be used in the present invention. Another ceramic powder may be coated on the surface of the model after the freezing process, if necessary.

The model manufactured as hitherto described is placed on the portion of the skull that has been excised to close the skull, and the surgery is completed by adhering the model to the skull with an appropriate bone-bonding adhesive in this embodiment. In a different embodiment, a metallic reinforcing material such as titanium that is safe to the living body and highly resistive to rust and corrosion may be embedded in the slurry of the ceramic to be injected a shown in the drawing for reinforcing the model, wherein the metal is processed into a mesh, or a thin plate or cylinder with punching. One side of the reinforce material is exposed to fix the skull to the exposed portion of the reinforce material with bolts.

In a further different embodiment, a powder of calcium phosphate may be added to the model. The powder used in the example is known by apatite (Trademark). The apatite powder is mainly added to the side face of the model, or to the portion when the model contacts the skull when closed, before firing the frozen model. Since an apatite layer is formed on the side face of the model by firing, the apatite layer helps osteogenesis to afford the apatite layer integrated with the skull. The model may be formed by firing a mixture of the ceramic powder and apatite powder in place of using only the ceramic powder, or a powder prepared by previously mixing the ceramic powder and apatite powder in an appropriate proportion may be adhered before firing in place of using the pure apatite powder. Otherwise, apatite may be adhered to a part of the model made of the ceramic. These layers can be well fitted to the model after firing to form a block as a whole.

The skull is naturally repaired after the surgery since the model for closing the excised portion of the skull is a precise reproduction of the excised portion as well as the surface configuration of the excised surface. Not so many models is needed to be previously prepared as in the prior art since the models are monolithically manufactured, thereby enabling the cost of the model to be saved. In addition, since the model is simultaneously manufactured with the advance of surgery, it may be completed within the time for completing the surgery to afford a margin of time for preparing the model during the surgery.

When a layer of calcium phosphate is formed on at least the side face of the model, the layer is integrated with the skull to allow the layer to help osteogenesis, thereby establishing a favorable prognosis. A good working environment can be maintained in this series of work since no toxic gases are generated. While application of the method according to the present invention has been hitherto described, it maybe widely applied to replacement of other injured bones and dental implant. Any method comparable to the procedure for the skull is considered to be within the scope of the present invention.

The above embodiments are discussed as to replacement of a skull to an artificial skull. However, it is no need to say that our invention can be applied to other surgical operation, for example, artificial teeth, recovering of bones and so on. Therefore, the term “skull” should be understood as equivalent with the above examples.

What is claimed is.

What is claimed:

1. A method for manufacturing an artificial skull model comprising the steps of:
forming an outer mold by duplicating an impression of the surface of a skull to be excised with a curing type impression material;
filling a soft impression material in the outer mold as a tray and pressing the soft impression material in the tray onto a portion where the skull has been excised to form a main mold;
releasing the main mold after filling an upper mold with the soft impression material to an extent capable of duplicating at least the impression of a side face of the main mold; and
replacing a remaining space after releasing the main mold with a slurry of ceramic powder followed by freezing the slurry to form a frozen model and removing and firing the frozen model.

2. A method for manufacturing an artificial skull model according to claim 1, further comprising a step of adhering a powder of calcium phosphate on at least a side face of the frozen model before firing.

3. A method for manufacturing an artificial skull model according to claim 1, wherein the slurry of the ceramic powder contains the powder of calcium phosphate.

4. A method for manufacturing an artificial skull model according to claim 2, wherein the slurry of the ceramic powder contains the powder of calcium phosphate.

5. A method for manufacturing an artificial skull model according to claim 1, wherein a metallic reinforcing material is embedded in the slurry of the ceramic powder before freezing the slurry.

6. A method for manufacturing an artificial skull model according to claim 2, wherein a metallic reinforcing material is embedded in the slurry of the ceramic powder before freezing the slurry.

7. A method for manufacturing an artificial skull model according to claim 3, wherein a metallic reinforcing material is embedded in the slurry of the ceramic powder before freezing the slurry.

8. An artificial skull model manufactured by the steps comprising:
forming outer mold by duplicating the impression of the surface of a skull to be excised with a curing type impression material;
filling a soft impression material in the outer mold as a tray and pressing the soft impression material in the tray onto a portion where the skull has been excised to form a main mold;
filling an upper mold to an extent capable of duplicating at least the impression of a side face of the main mold, followed by releasing the main mold;
replacing a remaining space after releasing the main mold with a slurry of a ceramic powder followed freezing the slurry to form a frozen model; and
removing and firing the frozen model.

9. An artificial skull model according to claim 8, further comprising the step of adhering a powder of calcium phosphate on at least a side face of the frozen model before firing the frozen model to provide a fired layer of calcium phosphate on the side face of the artificial skull model.

10. An artificial skull model according to claim 8, wherein the slurry of the ceramic powder contains the powder calcium phosphate.

11. An artificial skull model according to claim 9, wherein the slurry of the ceramic powder contains the powder calcium phosphate.

12. An artificial skull model according to claim 8, wherein the slurry of the ceramic powder is prepared by mixing the ceramic powder with a high melting point powder.

13. An artificial skull model according to claim 9, wherein the slurry of the ceramic powder is prepared by mixing the ceramic powder with a high melting point powder.

14. An artificial skull model according to claim 10, wherein the slurry of the ceramic powder is prepared by mixing the ceramic powder with a high melting point powder.

15. An artificial skull model according to claim 11, wherein the slurry of the ceramic powder is prepared by mixing the ceramic powder with a high melting point powder.

16. An artificial skull model according to claim 8, further comprising the step of embedding a metallic material in the slurry of the ceramic powder.

17. An artificial skull model according to claim 9, further comprising the step of embedding a metallic material in the slurry of the ceramic powder.

18. An artificial skull model according to claim 10, further comprising the step of embedding a metallic material in the slurry of the ceramic powder.

19. An artificial skull model according to claim 12, further comprising the step of embedding a metallic material in the slurry of the ceramic powder.

20. An artificial skull model according to claim 15, further comprising the step of embedding a metallic material in the slurry of the ceramic powder.
